(19) United States
(12) Patent Application Publication
(10) Pub. No.: US 2021/0166175 A1
(43) Pub. Date: Jun. 3, 2021

(54) DETERMINING AT LEAST ONE SCHEDULE FOR AT LEAST ONE TRANSPORT FROM A PLURALITY OF TRANSPORT

(71) Applicant: Siemens Mobility GmbH, München, Bayern (DE)

(72) Inventors: Philine Meister, Sunnyvale, CA (US); Frederik Deroo, München (DE); Georg von Wichert, München (DE)

(21) Appl. No.: 17/263,319

(22) PCT Filed: Jul. 9, 2019
(86) PCT No.: PCT/EP2019/068397

§ 371 Date: Jan. 26, 2021

(30) Foreign Application Priority Data
Aug. 2, 2018 (DE) 10 2018 212 968.1

(51) Int. Cl. G06Q 10/06; G07C 5/00; G06Q 10/04

(52) U.S. Cl. CPC G06Q 10/06312; G06Q 10/047; G07C 5/008

(57) ABSTRACT

Provided is a method for determining at least one schedule for a transport from a plurality of transport, having the steps of receiving at least one input data record; wherein the at least one input data record has user data for at least one user and at least one further piece of information; and determining the at least one schedule for the transport from the plurality of transport by optimizing an optimization function by taking into consideration the at least one input data record. Further, also provided is a corresponding unit and a computer program product.

### CROSS-REFERENCE TO RELATED APPLICATIONS

This application claims priority to PCT Application No. PCT/EP2019/068397, having a filing date of Jul. 9, 2019, which is based on German Application No. 10 2018 212 968.1, having a filing date of Aug. 2, 2018, the entire contents both of which are hereby incorporated by reference.

### FIELD OF TECHNOLOGY

The following relates to a computer-implemented method for determining at least one timetable for at least one transport from a plurality of transport. The following furthermore targets a corresponding determination unit and computer program product. The following may be applied in particular in the technical fields of automation and mobility.

### BACKGROUND

Timetables are known from the conventional art. The timetable usually defines the journey schedule of a transport in local and long-distance public transport and in rail freight transport. The timetable comprises the arrival and departure times of the transport at the respective stops. The timetable may furthermore comprise further information. The timetable may also be displayed using appropriate media.

The known approaches for creating a timetable are however insufficient with regard to changing factors, such as demand or anomalies. Demand depends on the season, day of the week and time of day. Rail-bound and road-bound transport accordingly reach their maximum capacities at times of high demand. This may result in delays, longer waiting times and lack of comfort for the user. The user is also referred to below as passenger. By contrast, transport travel at low capacity at times of low demand. This results in high costs and low profits for the operator of the transport. Anomalies are for example technical faults, accidents or construction works.

The approaches according to the conventional art take into account certain customer-specific and operator-specific criteria, in particular in the form of past user or operator experiences. However, the result of these approaches is always a fixed timetable. The resultant timetables are therefore defined and are thus not able to be adjusted or are not adaptive in terms of current circumstances or other changing factors, such as customer requirements or traffic levels.

Embodiments of the present invention therefore sets itself the object of providing a method for determining at least one timetable for at least one transport from a plurality of transport, which method is efficient and reliable and also allows an increased adjustment capability.

### SUMMARY

An aspect relates to a method for determining at least one timetable for at least one transport from a plurality of transport, having the steps of:
a. receiving at least one input data record; wherein
b. the at least one input data record contains user data of at least one user and at least one further item of information; and
c. determining the at least one timetable for the at least one transport from the plurality of transport by
   optimizing an optimization function taking into account the at least one input data record.

Embodiments of the invention accordingly target a method for determining a timetable for at least one transport from a plurality of transport. In other words, the method according to embodiments of the invention creates timetable information for a transport. The timetable may accordingly also be referred to as timetable information or route in accordance with which the transport travels. The transport is designed as any transport for road or rail travel, for example an automobile, a bus or a train. After being determined, the determined timetable may be output to a user for further use thereby. By way of example, a timetable for a predetermined destination or a predetermined route is created for a user. The timetable may be displayed to the user on a display of his terminal, such as a smartphone.

In a first method step, an input data record is received. The input data record may be received via one or more interfaces by a determination unit, such as an autonomous unit or software unit. The input data record comprises two different data records or items of information, specifically user data and one or more further items of information.

The user data are user-related data and may also be referred to as user requirements or user wishes. The user data may relate to current data or past data. By way of example, the user may specify particular, desired or essential user data for his current destination location. In addition or as an alternative, past user experiences may also be specified. The further item of information refers to background information and/or other conditions, such as transport and/or road or rail travel.

By way of example, the user data may contain required information, such as the starting point, the destination location and the departure time. The user may furthermore specify the user data with regard to his requirements, such as longest waiting time for the transport and/or longest travel time using the transport, etc. The further information may furthermore provide both general information about the traffic network and current circumstances or anomalies, such as traffic levels or accidents, etc.

In a second method step, the timetable is determined by optimizing an optimization function taking into account the at least one input data record. The target function of the optimization problem accordingly takes into account the user data and also further additional conditions such as for example traffic levels, other travel requests, available vehicles, cost and environmental requirements and the like. The optimization problem is a nonlinear problem containing additional conditions.

According to the conventional art, the transport follow previously defined routes and timetables. The transport depart from defined stops in particular at defined times. Changing factors, such as demand or accidents, are not taken into account to a sufficient degree. In contrast to the conventional art, the method according to embodiments of the invention advantageously allows a timetable to be determined flexibly and dynamically. The determined timetable is therefore not fixedly predefined or set. The timetable may be adjusted efficiently and reliably in real time to user requirements, demand and/or fault events.

In one refinement, the at least one user inputs the user data by way of a unit, the user data are retrieved from a storage unit or the user data are transmitted by another unit.

The user data may accordingly be generated in various ways and in particular be received by the determination unit or its interface.

The user may input the user data using a unit, such as a terminal, via a keypad or a voice command. The user data are received from the unit.

As an alternative, the user data may also be stored in a storage unit and be retrieved therefrom.

The user data are received from the storage unit. The storage unit may be designed as a database, cloud or other volatile or nonvolatile storage unit that is able to be accessed efficiently and reliably.

By way of example, the current user data may be buffer-stored, or past user data may be collected in a database.

As an alternative, the user data may also be received via another unit, such as a computing unit.

In a further refinement, the user data contain at least one item of user information selected from the group consisting of

starting location of the transport, destination location of the transport, departure time, arrival time, at least partially predetermined route, the user's distance from the starting location, travel time using the at least one transport, availability of the at least one transport, price limits and waiting time for the at least one transport.

In a further refinement, the at least one further item of information is selected from the group consisting of number of transport, respective size of the transport from the plurality of transport, other data regarding the at least one transport and data on the driver of the transport.

In a further refinement, the at least one further item of information is selected from the group consisting of a traffic situation, a traffic level, a traffic network, a fault, construction works, an accident, a closure, a demand, a boundary condition, a special case and other data with regard to the traffic or anomalies.

In order to avoid unnecessary repetitions, reference is made to the above explanations with regard to the user data and the further item of information. Both user requirements and other requirements with regard to the traffic or transport are advantageously taken into account in the optimization.

In a further refinement, the at least one timetable for the at least one transport from the plurality of transport specifies at least one optimum route for the user, in particular, in terms of minimum distance to the starting location of the at least one transport, minimum travel time using the at least one transport, minimum price for the at least one transport and minimum waiting time for the at least one transport.

The timetable may accordingly advantageously be adjusted flexibly and dynamically to the requirements, and thus in particular be tailored individually to the user. The traffic system may also respond to demand and other circumstances.

In a further refinement, the method furthermore comprises transmitting the at least one timetable to a unit.

The timetable is accordingly transmitted to a unit, such as for example terminal or computing unit. With reference to the above example, a user may transmit the user data via a terminal to the determination unit in order to determine his timetable. The determination unit determines the timetable and transmits it back to the terminal of the user. The timetable may be displayed to the user as a text message or other message on the terminal.

In a further refinement, the method furthermore comprises receiving at least one item of feedback from the user about the at least one timetable for the at least one transport from the plurality of transport; and

determining at least one expanded timetable for the at least one transport from the plurality of transport by
optimizing the optimization function taking into account the at least one item of feedback.

The user may accordingly respond after receiving the timetable. He may transmit feedback about the timetable back to the determination unit via his terminal or other computing unit. The feedback may be incorporated into the optimization as a new further item of information. By way of example, the further item of information may furthermore specify the maximum price or the maximum distance to the starting point. An optimization therefore takes place again on the basis of the feedback, and the timetable is improved.

In a further refinement, the at least one user inputs the at least one item of feedback by way of a unit, the at least one item of feedback is retrieved from a storage unit or the at least one item of feedback is transmitted by another unit.

In order to avoid unnecessary repetitions, reference is made to the above explanations with regard to the user data. The item of feedback may be generated in a manner similar or identical to the user data.

In a further refinement, the method furthermore comprises analyzing the at least one timetable and/or storing the at least one timetable.

The timetable may accordingly be transmitted to the terminal of the user for feedback. As an alternative, the timetable may however also be analyzed and/or stored, for example in order to construct an empirical record and to allow the experience to be incorporated into the optimization as a further item of information from a storage unit.

Embodiments of the invention furthermore relate to a determination unit for performing the above method. The unit may be designed as an autonomous unit, computing unit, control unit or another unit.

Embodiments of the invention furthermore relate to a computer program product (non-transitory computer readable storage medium having instructions, which when executed by a processor, perform actions) containing a computer program that has means for performing the method described above when the computer program is executed on a program-controlled device.

A computer program product, such as for example a computer program means, may be provided or supplied for example in the form of a storage medium, such as for example memory card, USB stick, CD-ROM, DVD, or else in the form of a downloadable file from a server in a network. This may be performed for example in a wireless communication network by transmitting a corresponding file containing the computer program product or the computer program means. A control device, such as for example an industrial control PC or a programmable logic controller, PLC for short, or a microprocessor for a smart card or the like in particular come into consideration as a program-controlled device.

### BRIEF DESCRIPTION

Some of the embodiments will be described in detail, with references to the following Figures, wherein like designations denote like members, wherein:

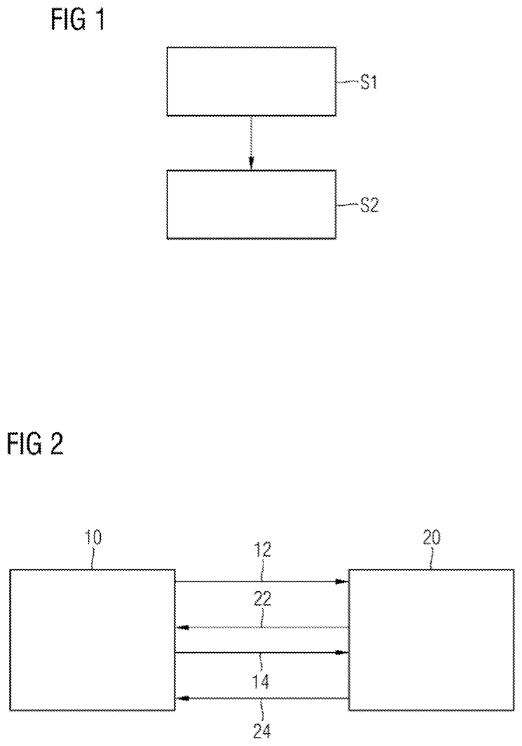

FIG. 1 shows a schematic flowchart of the method according to embodiments of the invention; and

FIG. 2 shows a determination unit according to embodiments of the invention.

### DETAILED DESCRIPTION

Preferred embodiments of the present invention are described below with reference to the figures.

FIG. 1 schematically illustrates a flowchart of the method according to embodiments of the invention with method steps S1 and S2. The individual method steps S1 and S2 may each be performed by the determination unit 20 or else the subunits thereof. Method steps S1 to S2 are explained in detail in FIG. 2 in accordance with the exemplary determination unit 20.

The input data record 12 comprises user data and one or more further items of information.

The user data may be specified by the user by way of an application on a terminal 10. By way of example, the user may specify his desired starting location, destination location, departure and/or arrival time as user data. The further item of information may relate to the plurality of transport, such as size, availability of the transport, or other boundary conditions, such as the current traffic situation. This input data record 12 is transmitted to the determination unit 20 for reception in order to determine the timetable for the transport.

As further exemplary input data, mention may be made of energy consumption, travel time, waiting time, the traffic level and closures. In order to avoid unnecessary repetitions, reference is made to the above explanations with regard to the input data record 12.

In a first method step S1, the determination unit 20 receives the input data record 12.

In a second method step S2, an optimization is performed by the determination unit 20 based on the received input data record 12. The result of this optimization is the timetable 22 for the transport. The timetable 22 may comprise stops and departure times that are able to be transmitted to the user. In contrast to the conventional art, the stops are not fixedly predefined stopping points. The stops may also sometimes be situated directly outside the user's front door, in particular depending on the available vehicle class and/or other boundary conditions.

The user may implement his transport wish on the basis of the determined timetable 22. By way of example, the above application may communicate to the user that it saves time to walk to the next street corner since a transport will shortly pass by there, instead of waiting for a long time. It is also possible to offer a collection service from the stop or the exclusive use of the transport, in particular depending on the capacity of the transport. Lower prices may also motivate the user to embark and disembark with other passengers at convenient stops along defined main routes and accept a longer walk.

The user may then respond to the received timetable 22 and transmit feedback 14 about the timetable to the determination unit 20. The feedback 14 may be incorporated into the optimization and therefore advantageously be taken into account as a decision, boundary condition and/or specification of the user. The result of this further optimization is the expanded timetable 24 for the transport.

The method according to embodiments of the invention accordingly ensures that user requirements are taken into account and user behavior is responded to dynamically. The method may be applied to any transport.

With regard to road traffic, the optimization may advantageously form main routes at times of congestion and thus high demand. On the other hand, in the case of low traffic levels and thus times of low demand, a service similar to a taxi may be formed. The transport may thereby be kept attractive even at night by offering a service similar to a taxi.

In the case of smaller vehicles, there is the option of allowing users to embark and disembark on side roads or of traveling in a “platoon” with other vehicles on main roads. In the case of autonomous vehicles, there is the option of using these and taking these out of service again easily and flexibly without personnel expenditure or costs.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for determining at least one timetable for at least one means of transport from a plurality of means of transport, the method comprising:
a. receiving at least one input data record; wherein:
b. the at least one input data record contains user data of at least one user and at least one further item of information; and
c. determining the at least one timetable for the at least one means of transport from the plurality of means of transport by optimizing an optimization function taking into account the at least one input data record.

2. The method as claimed in claim 1, wherein the at least one user inputs the user data by way of a unit, the user data are retrieved from a storage unit or the user data are transmitted by another unit.

3. The method as claimed in claim 1, wherein the user data contain at least one item of user information selected from the group consisting of:
a starting location of the means of transport, a destination location of the means of transport, a departure time, an arrival time, an at least partially predetermined route, the user's distance from the starting location, a travel time using the at least one means of transport, an availability of the at least one means of transport, price limits and a waiting time for the at least one means of transport.

4. The method as claimed in claim 1, wherein the at least one further item of information is selected from the group consisting of: a number of means of transport, a respective size of the means of transport, other data regarding the at least one means of transport and data on a driver of the means of transport.

5. The method as claimed in claim 4, wherein the at least one further item of information is selected from the group consisting of: a traffic situation, a traffic level, a traffic network, a fault, construction works, an accident, a closure, a demand, a boundary condition, a special case and other data with regard to the traffic or anomalies.

6. The method as claimed in claim 1, wherein the at least one timetable for the at least one means of transport specifies at least one optimum route for the user,
in terms of minimum distance to a starting location of the at least one means of transport, a minimum travel time using the at least one means of transport, a minimum price for the at least one means of transport, and a minimum waiting time for the at least one means of transport.

7. The method as claimed in claim 1, further comprising transmitting the at least one timetable to a unit.

8. The method as claimed in claim 7, further comprising:
receiving at least one item of feedback from the user about the at least one timetable for the at least one means of transport; and
determining at least one expanded timetable for the at least one means of transport by
optimizing the optimization function taking into account the at least one item of feedback.

9. The method as claimed in claim 8, wherein the at least one user inputs the at least one item of feedback by way of a unit, the at least one item of feedback is retrieved from a storage unit or the at least one item of feedback is transmitted by another unit.

10. The method as claimed in claim 1, further comprising analyzing the at least one timetable and/or storing the at least one timetable.

11. A determination unit for performing the method as claimed in claim 1.

12. A computer program product, comprising a computer readable hardware storage device having computer readable program code stored therein, said program code executable by a processor of a computer system to implement the method as claimed in claim 1 when the computer program is executed on a program-controlled device.
